(19) United States
(12) Patent Application Publication
(10) Pub. No.: US 2007/0229685 A1
(43) Pub. Date: Oct. 4, 2007

(54) Driving apparatus for solid-state image pickup element and driving method therefor

(75) Inventors: Yoshiyuki Tomizawa, Yokohama-shi (JP); Sei Iinuma, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/645,704

(22) Filed: Dec. 27, 2006

(30) Foreign Application Priority Data
Mar. 31, 2006 (JP) 2006-097543

(51) Int. Cl. H04N 3/14; H04N 5/335

(52) U.S. Cl. 348/294

(57) ABSTRACT

According to one embodiment, a driving apparatus for a solid-state image pickup element includes a generating unit configured to generate a drive voltage having an amplitude to obtain a predetermined multiplication gain to an electron-multiplying solid-state image pickup element, a calculating unit configured to calculate a change amount obtained when the multiplication gain of the solid-state image pickup element changes depending on elapsed time and conditions in actual use, and a correcting unit configured to correct an amplitude of the drive voltage output from the generating unit to obtain a predetermined multiplication gain on the basis of the change amount calculated by the calculating unit.

### CROSS-REFERENCE TO RELATED APPLICATIONS

This application is based upon and claims the benefit of priority from Japanese Patent Applications No. 2006-097543, filed Mar. 31, 2006, the entire contents of which are incorporated herein by reference.

### BACKGROUND

1. Field

One embodiment of the invention relates to a solid-state image pickup element driving apparatus to drive an electron-multiplying solid-state image pickup element and a driving method therefor.

2. Description of the Related Art

As is well known, an electron-multiplying solid-state image pickup element can change a multiplication gain depending on the amplitude of a drive voltage given to a multiplication unit of the solid-state image pickup element. In such an electron-multiplying solid-state image pickup element, even though a drive voltage having the same amplitude is given, depending on elapsed time, conditions in actual use, and the like, the multiplication gain may gradually decrease.

It is considered at present that the variation in gain occurs because electrons which should increase in number by electron multiplication do not increase in number depending on elapsed time, conditions of actual use, or the like. For this reason, in an electron-multiplying solid-state image pickup element which has been used for a long time, even though a drive voltage having an amplitude equal to that given in an initial state is given, a multiplication gain obtained in the initial state cannot be obtained any more.

Jpn. Pat. Appln. KOKAI Publication No. 2003-347317 discloses the configuration of a charge multiplying device (CMD) and a CMD-mounted charge coupled device (CCD) in which a first-phase drive voltage which performs charge multiplication by impact ionization is adjusted in cycle or number of time in comparison with a drive voltage of another layer to make it possible to arbitrarily adjust a multiplication factor.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an embodiment of the invention and is a diagram for explaining a schematic configuration of a monitoring camera;

FIG. 2 is a block diagram shown to explain a signal processing system of a color camera used in the monitoring camera in the embodiment;

FIG. 3 is a graph shown to explain a variation in gain occurring with elapsed time of an electron-multiplying CCD used in a color camera in the embodiment;

FIG. 4 is a graph shown to explain a variation in gain with a multiplication gain of the electron-multiplying CCD used in the color camera in the embodiment;

FIG. 5 is a graph shown to explain a variation in gain with a saturation area of the electron-multiplying CCD used in the color camera in the embodiment; and

FIG. 6 is a flow chart shown to explain a correcting operation of a variation in gain by a control unit used in the color camera in the embodiment.

### DETAILED DESCRIPTION

Various embodiments according to the invention will be described hereinafter with reference to the accompanying drawings. In general, according to one embodiment of the invention, a driving apparatus for a solid-state image pickup element includes: a generating unit configured to generate a drive voltage having an amplitude to obtain a predetermined multiplication gain to an electron-multiplying solid-state image pickup element; a calculating unit configured to calculate a change amount obtained when the multiplication gain of the solid-state image pickup element changes depending on elapsed time and conditions in actual use; and a correcting unit configured to correct an amplitude of the drive voltage output from the generating unit to obtain a predetermined multiplication gain on the basis of the change amount calculated by the calculating unit.

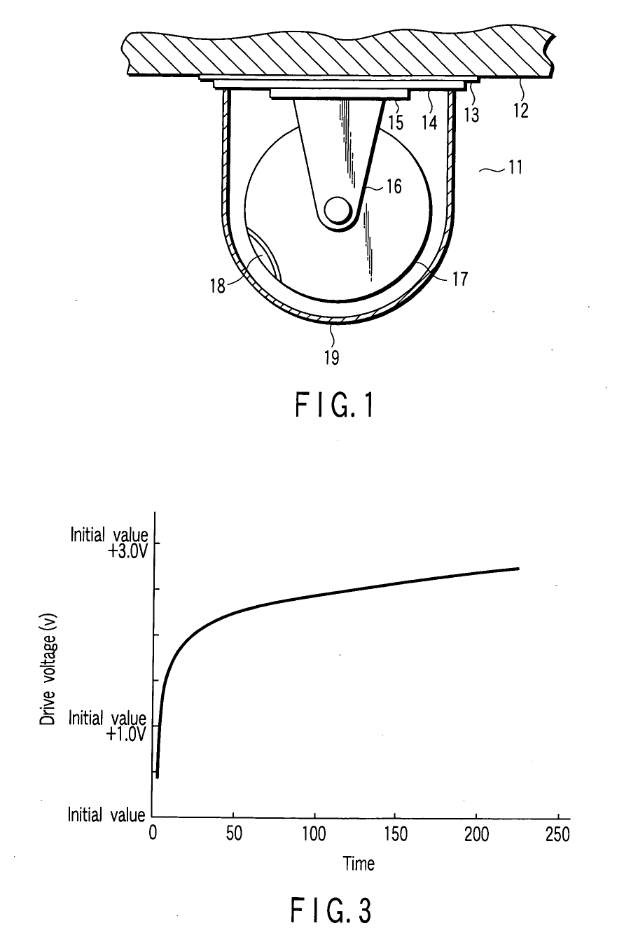

FIG. 1 shows an outline of a security camera 11 explained in the embodiment. The security camera 11 is arranged on, for example, a ceiling 12 in a building through an attaching plate 13. A support plate 14 is fixed to the attaching plate 13. A rotating plate 15 is pivotally supported at the center portion of the support plate 14.

On the rotating plate 15, a pair of support pieces 16 (only one of them is shown in FIG. 1) is arranged downward in the figure while sandwiching a pivotal center thereof. A color camera 17 which is formed to have an almost spherical shape is pivotally supported between the pair of support pieces 16. In this case, on the color camera 17, an image pickup lens 18 is exposed at an outermost position of the pivoted color camera 17.

For this reason, in the color camera 17, the rotating plate 15 is pivoted to make it possible to move the image pickup lens 18 in a pan direction. The color camera 17 itself is pivoted to make it possible to move the image pickup lens 18 in a tilt direction. In this case, the rotating plate 15 and the color camera 17 are pivoted by a pan motor and a tilt motor (not shown) in FIG. 1, respectively.

The color camera 17 is covered with a transparent cover 19. One end of the cover 19 is formed to have a semi-spherical shape corresponding to the shape of the color camera 17, and the other end thereof is formed to have a cylindrical shape with an opening. The cover 19 houses the color camera 17 therein, and an opening end of the transparent cover 19 is fixed to a peripheral part of the support plate 14 to cover the color camera 17.

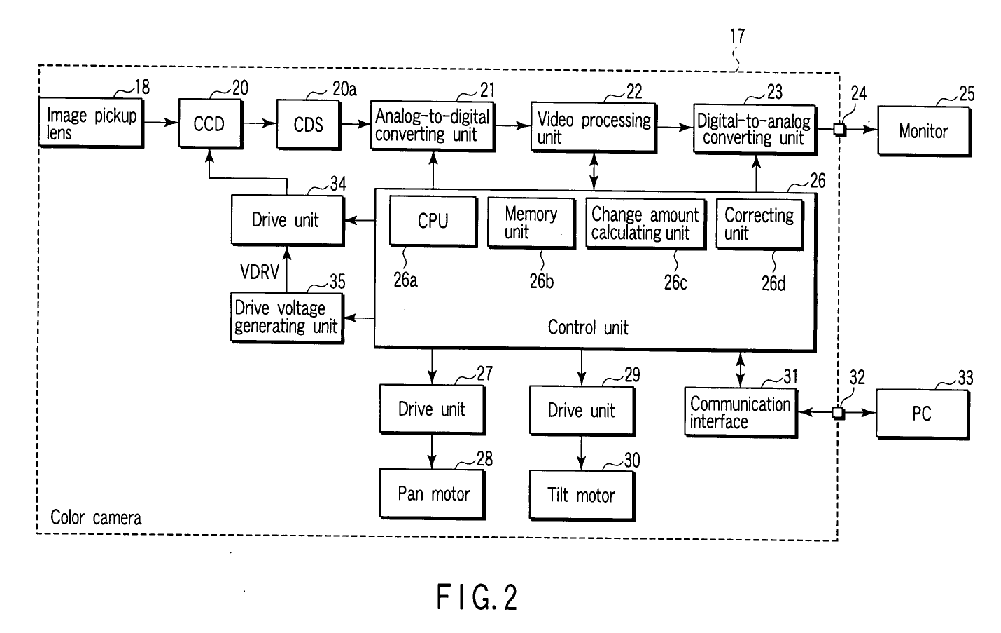

FIG. 2 shows a signal processing system of the color camera 17. More specifically, an optical image of an object being incident from the image pickup lens 18 is focused on an electron-multiplying CCD 20 and converted into a video signal corresponding to the optical image. The video signal output from the electron-multiplying CCD 20 is reduced in noise by a co-related double sampling (CDS) 20a, digitized by an analog-to-digital converting unit 21, supplied to a video processing unit 22, and subjected to predetermined video signal processing.

In the video processing unit 22, the input video signal is subjected to video signal processing such as a sharpness process, a contrast process, a gamma correction process, a white balance process, a defective pixel correction process, and a compression process. The video signal output from the video processing unit 22 is analogized by a digital-to-analog converting unit 23 and serves to video display by an external monitor 25 through an output terminal 24.

The color camera 17 causes a control unit 26 to integrally control all operations including the image pickup operation. The control unit 26 incorporates a central processing unit (CPU) 26a and receives control information from a personal computer (PC) 33 (described later) to respectively control the units such that the control contents are reflected.

In this case, the control unit 26 uses a memory unit 26b. The memory unit 26b mainly includes a read only memory (ROM) in which a control program executed by the CPU 26a is stored, a random access memory (RAM) which provides a working area to the CPU 26a and a nonvolatile memory in which various pieces of setting information, control information, and the like are stored.

The control unit 26 can control a rotating direction, a rotating speed, and the like of the pan motor 28 through a drive unit 27. Furthermore, the control unit 26 can control a rotating direction, a rotating speed, and the like of the tilt motor 30 through a drive unit 29.

The control unit 26 is connected to the external PC 33 through a communication interface unit 31 and an input/output terminal 32. In this manner, the control unit 26 outputs the digital video signal subjected to the signal processing in the video processing unit 22 to the PC 33 to make it possible to cause the PC 33 to display an image. On the basis of the control information supplied from the PC 33, the respective units can be controlled.

The control unit 26 controls a drive unit 34 to drive the CCD 20. The drive unit 34 controls the CCD 20 by a multiplication gain depending on an amplitude of a drive voltage VDRV output from a drive voltage generating unit 35. In addition, the control unit 26 controls the amplitude of the drive voltage VDRV output from the drive voltage generating unit 35 in order to obtain a multiplication gain required by the PC 33.

The control unit 26 includes a change amount calculating unit 26c which calculates a gain change amount in consideration of a variation in gain occurring in the multiplication gain of the CCD 20 depending on elapsed time, conditions of actual use, and the like, and a correcting unit 26d which corrects the amplitude of the drive voltage VDRV output from the drive voltage generating unit 35 to always correctly obtain a multiplication gain required on the basis of the calculated gain change amount.

More specifically, it is known that, in the electron-multiplying CCD 20, even though the drive voltage VDRV having the same amplitude is given, the multiplication gain gradually decreases depending on elapsed time, conditions in actual use, and the like, i.e., a variation in gain occurs. In this case, as conditions in actual use, a required multiplication gain, the number of saturation pixels (saturation area), and the like considerably influence the CCD 20.

FIG. 3 shows a measurement which exhibits a relationship between elapsed time and an amplitude of a drive voltage VDRV necessary to obtain a predetermined multiplication gain. It is understood that unless the amplitude of the drive voltage VDRV is increased with elapsed time, the same multiplication gain cannot be obtained.

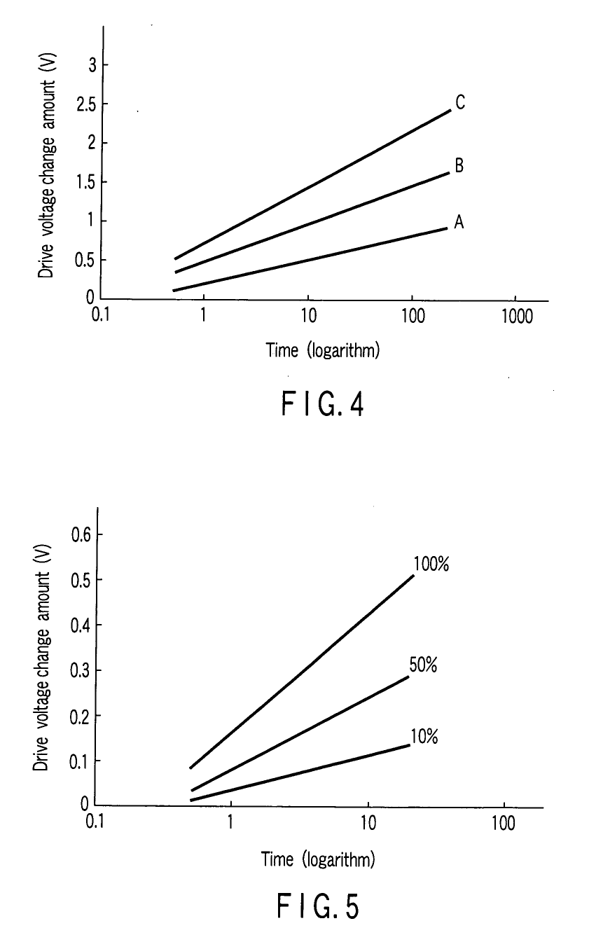

FIG. 4 shows a measurement in which the drive voltage VDRV is given by A, B, and C (A<B<C), i.e., gain change amounts generated with elapsed time at the three multiplication gains are expressed by change amounts of the drive voltage VDRV required to obtain the same multiplication gain. It is understood that, when the multiplication gain becomes high, i.e., when the drive voltage VDRV becomes high, the gain change amount increases.

FIG. 5 shows a measurement in which, when a saturation area occupies 100%, 50%, and 10% of the total number of pixels of the CCD 20, gain change amounts generated with elapsed time are expressed by change amounts of the drive voltage VDRV required to obtain the same multiplication gain. It is understood that the gain change amount increases when the saturation area becomes large.

Therefore, in the embodiment, the change amount calculating unit 26c of the control unit 26 calculates a gain change amount at the present time by comprehensively considering various factors such as elapsed time, a multiplication gain, and a saturation area which cause a variation in gain in the CCD 20. On the basis of the calculated gain change amount, the correcting unit 26d corrects the amplitude of a drive voltage VDRD such that a multiplication gain currently required is correctly obtained.

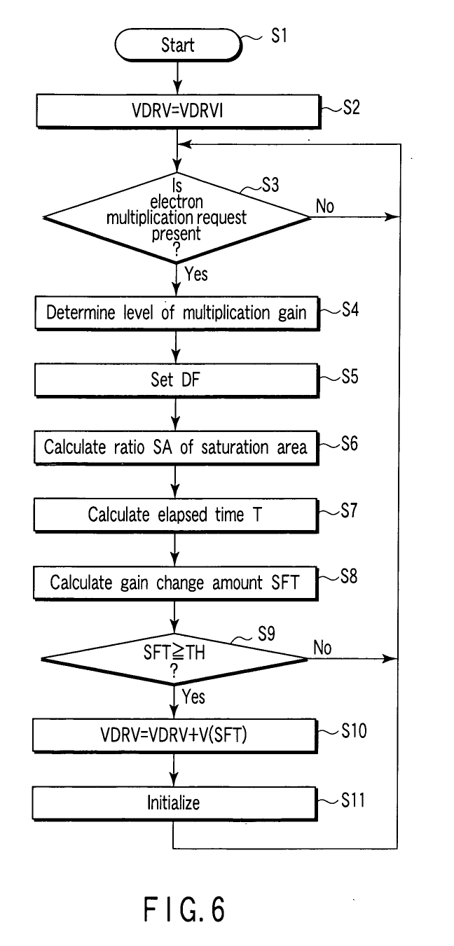

FIG. 6 is a flowchart obtained by collecting correcting operations performed by the change amount calculating unit 26c and the correcting unit 26d. More specifically, when the processing is started (block S1), the correcting unit 26d sets the amplitude of the drive voltage VDRD output from the drive voltage generating unit 35 at a predetermined initial value VDRDI in block S2.

The change amount calculating unit 26c determines whether electron multiplication is required to the CCD 20 in block S3. When it is determined that the electron multiplication is required (YES), a level of a multiplication gain is determined in block S4. The level of the multiplication gain changes in five blocks, e.g., EM (electron multiplying) 5 (MAX) to EM1 (MIN).

Thereafter, the change amount calculating unit 26c sets damage factors (DF) corresponding to the levels EM5 to EM1 of the determined multiplication gain in block S5. The DF is a coefficient obtained by weighting damage to the CCD 20 depending on the level of the multiplication gain. For example, the coefficients are set at 10 for EM5, 5 for EM4, 2.5 for EM3, 1.3 for EM2, and 0.6 for EM1.

The change amount calculating unit 26c calculates a ratio SA (saturation area) of a saturation area occupied in the total number of pixels TP (total pixel) of the CCD 20 in block S6. When the number of pixels (the number of saturation pixels) the luminance levels of which reach the maximum value is represented by SP (saturation pixel), the ratio SA can be given by the following equation:

SA=SP/TP.

Thereafter, the change amount calculating unit 26c calculates elapsed time T of the CCD 20 in block S7. When total time for which the CCD 20 is driven in electron multiplication is represented by T, the elapsed time T is given by the following equation:

T=T+( 1/60) (in case of 60 fps).

The change amount calculating unit 26c calculates a gain change amount SFT of the CCD 20 in block S8. The gain change amount SFT can be obtained by the following equation:

SFT=SFT+DF×SA×logT.

In this case, the correcting unit 26d determines in block S9 whether the gain change amount SFT of the CCD 20 exceeds a predetermined threshold value TH set in advance. When it is determined that the gain change amount SFT does not exceed the predetermined threshold value TH (NO), the control is returned to the process in block S3.

When it is determined in block S9 that the gain change amount SFT of the CCD 20 exceeds the threshold value TH (YES), the correcting unit 26d controls the drive voltage generating unit 35 in block S10 such that a correction voltage V (SFT) corresponding to the gain change amount SFT is added to a current drive voltage VDRD and the resultant value is output.

The correcting unit 26d initializes the gain change amount by using the value obtained by adding the correction voltage V (SFT) to the initial drive voltage VDRDI of the drive voltage VDRD as the amplitude of the current drive voltage in block S11. Thereafter, the control is returned to the process in block S3.

According to the embodiment described above, a gain change amount of the CCD 20 at the present is calculated by comprehensively considering various factors such as elapsed time, a multiplication gain, and a saturation area. On the basis of the calculated gain change amount, the amplitude of the drive voltage VDRD is corrected such that a required multiplication gain is correctly obtained. For this reason, even though a variation in gain occurs depending on elapsed time, conditions in actual use, and the like, the electron-multiplying CCD 20 can be driven to always obtain a stable multiplication gain.

As shown in FIG. 3, a variation in gain with elapsed time considerably varies in an initial state, and moderately varies subsequently. For this reason, the correcting operation is performed until an initial predetermined period of time has elapsed, and the correcting operation is not performed subsequently. Even in this configuration, an almost stable multiplication gain can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A driving apparatus for a solid-state image pickup element, comprising:
a generating unit configured to generate a drive voltage having an amplitude to obtain a predetermined multiplication gain to an electron-multiplying solid-state image pickup element;
a calculating unit configured to calculate a change amount obtained when the multiplication gain of the solid-state image pickup element changes depending on elapsed time and conditions in actual use; and
a correcting unit configured to correct an amplitude of the drive voltage output from the generating unit to obtain a predetermined multiplication gain on the basis of the change amount calculated by the calculating unit.

2. A driving apparatus for a solid-state image pickup element according to claim 1, wherein
the calculating unit is configured to calculate a change amount of a multiplication gain on the basis of use time of the solid-state image pickup element, a level of a multiplication gain at which the solid-state image pickup element is driven, and the number of saturation pixels of the solid-state image pickup element.

3. A driving apparatus for a solid-state image pickup element according to claim 1, wherein
the calculating unit is configured to calculate a change amount of the multiplication gain on the basis of total use time for which the solid-state image pickup element is driven in electron multiplication, weighting coefficient set to show damage to the solid-state image pickup element depending on a level of a multiplication gain at which the solid-state image pickup element is driven, and a ratio of the number of saturation pixels occupied in the total number of pixels of the solid-state image pickup element.

4. A driving apparatus for a solid-state image pickup element according to claim 1, wherein
the calculating unit is configured to calculate a change amount of a multiplication gain by performing an arithmetic operation given by DF×SA×logT on the basis of total use time T for which the solid-state image pickup element is driven in electron multiplication, a weighting coefficient DF set to show damage to the solid-state image pickup element depending on a level of the multiplication gain at which the solid-state image pickup element is driven, and a ratio SA of the number of saturation pixels occupied in the total number of pixels of the solid-state image pickup element.

5. A driving apparatus for a solid-state image pickup element according to claim 1, wherein
the correcting unit is configured to correct an amplitude of a drive voltage output from the generating unit when the change amount calculated by the calculating unit exceeds a predetermined threshold value set in advance.

6. A color camera device having an electron-multiplying solid-state image pickup element, comprising:
a generating unit configured to generate a drive voltage having an amplitude to obtain a predetermined multiplication gain to the solid-state image pickup element;
a processing unit configured to perform predetermined signal processing to an output signal from the solid-state image pickup element driven on the basis of the drive voltage output from the generating unit and to output the signal to the outside;
a calculating unit configured to calculate a change amount obtained when the multiplication gain of the solid-state image pickup element changes depending on elapsed time and conditions in actual use; and
a correcting unit configured to correct an amplitude of the drive voltage output from the generating unit to obtain a predetermined multiplication gain on the basis of the change amount calculated by the calculating unit.

7. A driving method for an solid-state image pickup element comprising:
a first block of generating a drive voltage having an amplitude to obtain a predetermined multiplication gain to an electron-multiplying solid-state image pickup element;
a second block of calculating a change amount obtained when the multiplication gain of the solid-state image pickup element changes depending on elapsed time and conditions in actual use; and
a third block of correcting an amplitude of the drive voltage output in the first block to obtain a predetermined multiplication gain on the basis of the change amount calculated in the second block.

8. A driving method for a solid-state image pickup element according to claim 7, wherein
in the second block, a change amount of a multiplication gain is calculated on the basis of use time of the solid-state image pickup element, a level of a multiplication gain at which the solid-state image pickup element is driven, and the number of saturation pixels of the solid-state image pickup element.

9. A driving method for a solid-state image pickup element according to claim 7, wherein
in the second block, a change amount of the multiplication gain is calculated on the basis of total use time for which the solid-state image pickup element is driven in electron multiplication, a weighting coefficient set to show damage to the solid-state image pickup element depending on a level of a multiplication gain at which the solid-state image pickup element is driven, and a ratio of the number of saturation pixels occupied in the total number of pixels of the solid-state image pickup element.

10. A driving method for a solid-state image pickup element according to claim 7, wherein
the second block includes:
a first calculating block of calculating total use time T for which the solid-state image pickup element is driven in electron multiplication;
a second calculating block of calculating a weighting coefficient DF set to show damage to the solid-state image pickup element depending on a level of the multiplication gain at which the solid-state image pickup element is driven,
a third calculating block of calculating a ratio SA of the number of saturation pixels occupied in the total number of pixels of the solid-state image pickup element; and
a fourth calculating block of performing an arithmetic operation given by DF x SA x logT depending on respective values calculated in the first to third blocks to calculate a change amount of the multiplication gain.

11. A driving method for a solid-state image pickup element according to claim 7, wherein
in the third block, an amplitude of a drive voltage output in the first block is corrected when the change amount calculated in the second block exceeds the predetermined threshold value set in advance.
